(19) United States
(12) Patent Application Publication
(10) Pub. No.: US 2006/0217145 A1
(43) Pub. Date: Sep. 28, 2006

(54) Secure digital wireless communication system

(76) Inventor: Ronald G. Pace, Naperville, IL (US)

Correspondence Address: WALLENSTEIN & WAGNER, LTD., 311 SOUTH WACKER DRIVE, 53RD FLOOR, CHICAGO, IL, 60606, US

(21) Appl. No.: 11/089,321

(22) Filed: Mar. 24, 2005

(51) Int. Cl. H04M 1/00

(52) U.S. Cl. 455/550.1

(57) ABSTRACT

A wireless audio communication system and monitor is disclosed, comprising a transmitter and a receiver. The transmitter comprises an input for receiving audio information, and a filter for modifying the audio information. The transmitter further comprises a converter for converting the audio information into a digital audio information, and an antenna for wirelessly transmitting the digital audio information at a selected radio frequency. The receiver comprises an antenna for receiving the transmitted digital audio information, and a filter for modifying the digital audio information. The receiver further comprises a converter for converting the digital audio information into the audio information, and an output for communicating the audio information.

### TECHNICAL FIELD

The invention relates to a secure wireless communication system. More specifically, the present invention relates to a system for an improved system and method for wireless communication between two locations, and the wireless monitoring of one location from a second location.

### BACKGROUND OF THE INVENTION

Wireless communication in the abstract has been known and popular for some time. In recent years, various improvements in radio transmission bandwidth and signal strength have enhanced the number and type of wireless communication systems available to consumers. An exemplary wireless monitoring system is disclosed in U.S. Pat. No. 6,759,961 to Fitzgerald et al. Various other exemplary wireless monitoring systems are currently offered for sale by Fisher-Price, among others.

Wireless monitoring systems can be used for a variety of purposes, such as home security, intercom devices, and law enforcement. Another application particularly suited for wireless monitoring systems is a baby monitor, in which a transmitting device is positioned at the location of an infant, for example, a baby crib, and captures noises made by the infant. A receiving device is positioned elsewhere, such that a parent can attend to other duties while listening to the sounds transmitted from the infant's location.

One shortcoming of present wireless monitoring systems is that the sound data transmitted from the transmitting device to the receiving device is typically in analog form. For example, the sound is in the standard analog waveform, and is therefore subject to standard waveform degradation. In such systems, owing to analog signal degradation, the quality of the sound received by the receiver will be inherently less than the quality of the sound sent by the transmitter. Across a substantial distance, the reduction in sound quality can be so substantial as to render the received sounds indistinguishable from background noise.

Another shortcoming of present wireless monitor systems is that they are susceptible to eavesdropping. The audio transmission between the transmitting and receiving devices is a standard radio transmission, which can be received by a standard radio reception device listening at the correct frequency. Such devices are notoriously insecure, and for the same reason can interfere with other radio transmissions such as a wireless phone or stereo system. Conversely, such wireless monitor devices receive interference from the other radio devices as well, sometimes requiring the user to place the devices in awkward places to avoid interference.

The present invention is provided to solve the problems discussed above and other problems, and to provide advantages and aspects not provided by prior systems and/or methods of this type. A full discussion of the features and advantages of the present invention is deferred to the detailed description, which proceeds with reference to the accompanying drawings.

### SUMMARY OF THE INVENTION

A secure wireless communication system is provided comprising a transmitter and a receiver. The transmitter has an input for receiving audio information and a filter for modifying the audio information. The transmitter further comprises a selector for selecting a radio frequency, and an antenna for transmitting the modulated audio information on the selected radio frequency carrier. The receiver has an antenna for receiving the modulated audio information from the transmitter, and a filter for modifying the audio information. The receiver further comprises an output for communicating the audio information.

It is an object of the present invention to provide a wireless communication system that will both transmit and receive audio information having a higher sound quality than systems known in the art. To that end, the transmitter of the present system is, in one embodiment, provided with a converter to convert captured analog sound to a digital equivalent prior to transmission. Conversely, the receiver in that embodiment is provided with a converter for converting the received digital audio information into an analog form prior to communicating the information to the sound output.

It is a further object of the present invention to provide for a wireless communication system for the secure transmission of audio information. In an embodiment, the transmitter of the present system is provided with a translator for translating the audio information into an encrypted audio information prior to transmission. Likewise, in that embodiment, the receiver is provided with a translator for translating received encrypted audio information into non-encrypted audio information, prior to communicating the information to the sound output.

In an embodiment, the transmitter of the present invention is provided with an amplifier to amplify the audio information captured by the input, thereby increasing the sound quality and dynamic range of the captured audio information. Preferably, the receiver is also provided with an amplifier for further improving the sound quality and volume level of the audio information.

It is a further object of the present invention to provide a wireless communication system that will have a greater range of transmission capability from the transmitter to the receiver. In an embodiment, the transmitter is provided with a radio frequency (“RF”) power amplifier for increasing the distance over which the transmitter can transmit the audio information. Preferably, the receiver also comprises a low noise amplifier (“LNA”) for further increasing the operable distance at which the receiver can receive transmissions from the transmitter.

It is a further object of the present invention to provide a wireless communication system that will be less susceptible to interference from neighboring radio frequency devices, and will be less likely to provide interference for those neighboring devices. In an embodiment, the transmitter is provided with a radio frequency filter for determining a radio frequency at which to transmit the audio information. Preferably, the receiver likewise comprises a radio frequency filter for receiving the audio information transmitted at the radio frequency selected by the transmitter.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a flowchart illustration of a transmitter and the components thereof configured for transmitting audio information in accordance with the principles of the present invention;

FIG. 2 is a software flowchart illustrating operations performed by a microcontroller installed within a transmitter configured in accordance with the principles of the present invention;

FIG. 3 is a flowchart illustration of a receiver and the components thereof configured for receiving audio information in accordance with the principles of the present invention; and,

FIG. 4 is a software flowchart illustrating operations performed by a microcontroller installed within a receiver configured in accordance with the principles of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

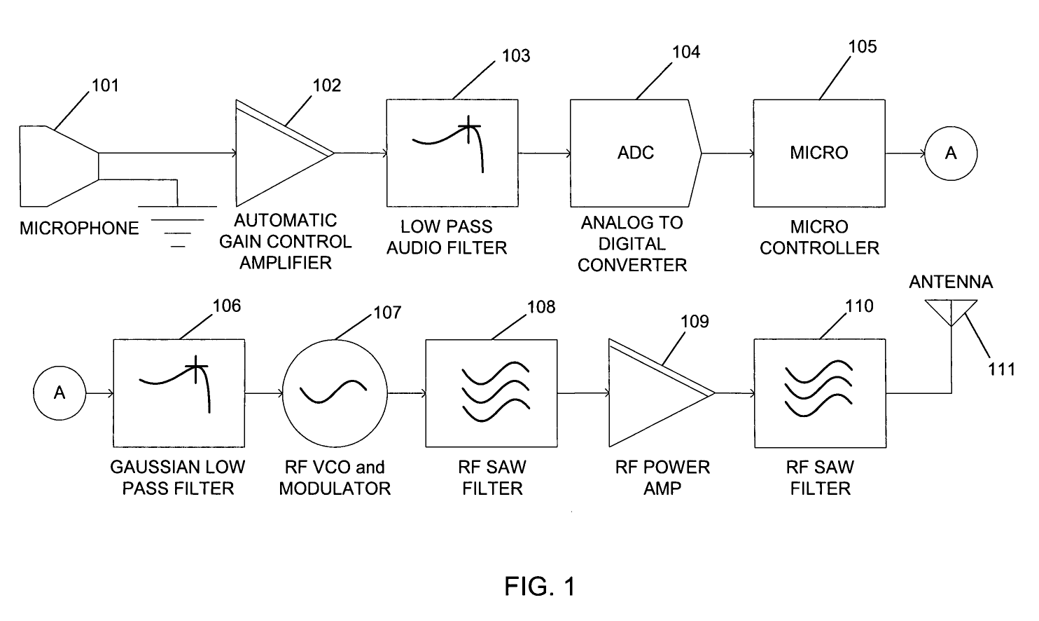

Referring initially to FIG. 1, there is illustrated a block diagram for a wireless transmitter 100 configured in accordance with the principles of the present invention. The wireless transmitter 100 includes an input 101. In a preferred embodiment and as illustrated in FIG. 1, input 101 is a microphone. It will be understood that input 101 is any input capable of receiving audio information, including an eighth- or quarter-inch stereo input port, and an RCA input port. A microphone for the present invention is either directional or omni-directional, for receiving sound in a frequency range of at least 50 Hz to 20 kHz.

The transmitter 100 includes a filter 103, 106, 108, 110 for modifying the audio information and radio signal. As illustrated in FIG. 1, a variety of different types of filters may be used in the present invention without departing from the principles thereof. In one embodiment, the filter is a low pass audio filter 103. The low pass audio filter 103 allows lower frequency signals to pass through the filter 103, while blocking undesirable high frequency signals. Those high frequency signals are highly attenuated by the filter 103, thereby eliminating the static “squeal” common with short-wave radio transmission and improving the quality of the audio information. In that embodiment, the low pass audio filter 103 can be constructed of either passive or active electronic components.

In another embodiment, the filter for modifying the audio information is a Gaussian low pass filter 106. A Gaussian low pass filter 106 in the present system is advantageous for use in an embodiment involving an analog-to-digital (“A/D”) converter 104. When analog audio information is converted to digital form, the resulting audio signal is a square waveform. A Gaussian low pass filter 106 can be used to “smooth” the edges of that digitized audio waveform, resulting in a waveform suitable for frequency modulation (“FM”). As will be understood by one of skill in the art, a Gaussian low pass filter 106 is essentially an equation applied upon the input audio information signal to approximate a Gaussian curve. The Gaussian low pass filter 106 is also useful for achieving radio transmission compliance with Part 15 of the rules of the Federal Communications Commission. While it is particularly advantageous to use the Gaussian low pass filter 106 in an embodiment with the A/D converter 104, it is to be understood that the Gaussian low pass filter 106 can also be used in the present invention without the A/D converter 104.

In another embodiment, the filter for modifying the radio frequency signal is a surface acoustic wave (“SAW”) filter 108. The purpose of the SAW filter 108 is to accept radio waves within a desired frequency range, while rejecting radio waves outside of the designed range. In any RF transmission, captured audio information will necessarily include information at undesirable frequencies, usefully heard by the user as a background static “hiss”. Furthermore, audio information transmitted at frequencies relatively close to each other, such as a cordless phone and a standard home radio receiver, can be more effectively isolated from each other by using the SAW filter 108, whereby interference from other radio frequency devices can be reduced.

As illustrated in FIG. 1, the filters 103, 106, 108, 110 are not mutually exclusive. All of them can be used as filters with the present invention. In the combination illustrated, the filters 103, 106, 108, 110 are positioned so as to create the highest quality audio information to be transmitted by the transmitter 100. As further illustrated in FIG. 1, the filters 103, 106, 108, 110 may be used repetitively. In a preferred embodiment, for example, two SAW filters 108, 110 are used to enhance the quality of the RF signal prior to transmission.

The transmitter 100 further comprises a selector for selecting a radio frequency at which to transmit the modulated audio information. The selected radio frequency can be pre-programmed into the transmitter 100, such that by default, the audio information will be transmitted at the selected radio frequency. In another embodiment, a selector switch is provided for the user to select a radio frequency, to which the frequency modulator 107 is tuned to frequency modulate and transmit the digitized audio information.

The transmitter 100 further comprises an antenna 111, which is used to radiate electromagnetic waves at the selected frequency. Antenna 111 converts radio frequency electrical energy to radiated electromagnetic energy. The size of antenna 111 is determined by the frequency of the signal to be transmitted. In a preferred embodiment, a wire cut to one-half wavelength is sufficient for the purposes of the present invention.

In one embodiment, the transmitter 100 further comprises an A/D converter 104, which converts the captured analog audio information to a digital signal representing equivalent information. As will be understood by one of skill in the art, A/D converter 104 samples and stores a plurality of data points of the amplitude of the captured input analog audio information, and based on those stored sample points, creates a digitally equivalent signal. It will be further understood by those of skill in the art that in the present invention, a variety of A/D conversion algorithms can be used without departing from the principles of the invention, including Delta-Sigma, CVSD, ADPCM, PCM, uLaw, aLaw and the like.

In one embodiment, the transmitter 100 further comprises a microcontroller 105, which is used to control the routing of data through the various electrical components of the transmitter 100. As illustrated in FIG. 1, microcontroller 105 further allows the trafficking of the digital data stream from the A/D converter 104 to a radio frequency modulator 107. In one embodiment of the present invention, microcontroller 104 can add packet information, error correction and/or encryption security to the audio information that is to be transmitted by the transmitter 100. Microcontrollers capable of use in the present invention for those tasks are currently available from Motorola, Texas Instruments, Cypress, Microchip and Amtel, among others.

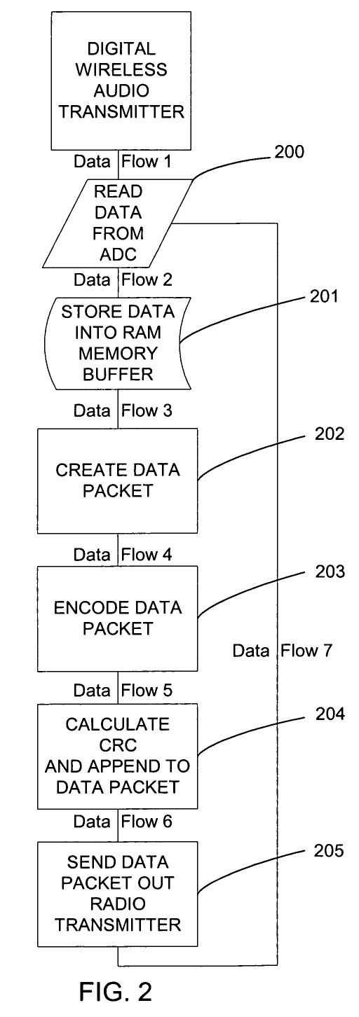

As illustrated in FIG. 2, a software diagram is illustrated for use with a microcontroller 105 installed in the transmitter 100. At initial step 200, digital audio information is received by the microcontroller 105 from the A/D converter 104, and stores that information in a memory, as illustrated in step 201. It will be understood that the received audio information is stored in memory essentially as it is received; that is, steps 200 and 201 are performed nearly simultaneously. Next, at step 202, the microcontroller 105 creates a data packet to accompany the transmission of the audio information. It will be understood by one of skill in the art that a data packet is a method of transmitting information so as to include meta-data, i.e., information about the transmitted information. In the present invention, the meta-data in the data packet can include error control information and encryption information. In one embodiment, and as illustrated at step 203, the audio information is encrypted. Information necessary to decrypt the encrypted audio information may be stored as meta-data in the data packet awaiting transmission, or can be stored in a microcontroller 317 installed within the receiver 300.

In one embodiment, and as illustrated at step 204, error checking information can be added as meta-data to the data packet awaiting transmission. It will be appreciated by one of skill in the art that a variety of encryption and error-checking algorithms can be used with the present invention without departing from the principles thereof. Encryption is useful in the present invention, so as to avoid surreptitious eavesdropping upon the transmissions from the transmitter 100. Error checking is useful in the present invention, so as to provide a way for the receiver 300 to ensure that all of the data transmitted by the transmitter 100 was actually received.

Referring again to FIG. 1, in one embodiment, the transmitter 100 further comprises an audio amplifier 102, 109. The amplifier may be an automatic gain control amplifier 102, which amplifies the strength of the audio information captured by the microphone 101. The amplifier 102 includes a variable gain element that dynamically adjusts the voltage level from the microphone, and essentially increases the amount of audio information that can be effectively captured by the microphone 101. The amplifier 102 provides dynamic amplification, such that when a low-level signal is received from the microphone 101, the amplifier 102 amplifies the gain strength from that signal, whereas when a high-level signal is received from the microphone 101, the amplifier 102 provides less gain strength to that signal. Electronic components for constructing an exemplary automatic gain control amplifier 102 for use in the present system are available from Analog Devices, part no. SSM2167.

Another amplifier for use in the transmitter 100 is a radio frequency power amplifier 109, which boosts the voltage level or power level of a signal, thereby creating a linear replica of the input signal, but with enhanced power level prior to transmission. The purpose of the power amplifier 109 is to increase the signal strength of the transmitter 100, and thus enhance both the distance at which transmitter 100 and receiver 300 may effectively communicate, and increase the clarity of the audio information received by receiver 300. The output signal from the power amplifier 109 may also be a non-linear analog function of the input signal. As illustrated in FIG. 1, the automatic gain control amplifier 102 and the radio frequency power amplifier 109 are not mutually exclusive of each other, and indeed are preferably used simultaneously in the transmitter 100 assembly.

In one embodiment, transmitter 100 further comprises a voltage control oscillator 107, which changes its frequency according to a control input, thereby creating a radio frequency carrier signal. The voltage control oscillator 107 optionally includes a radio frequency modulator, which in turn modulates the frequency of the voltage control oscillator 107 output, thereby creating a frequency-modulated signal for FM transmission. Voltage control oscillator 107 and radio frequency modulator are preferably, and as illustrated, contained in the same discrete electronic component, but may be separated without departing from the principles of the present invention.

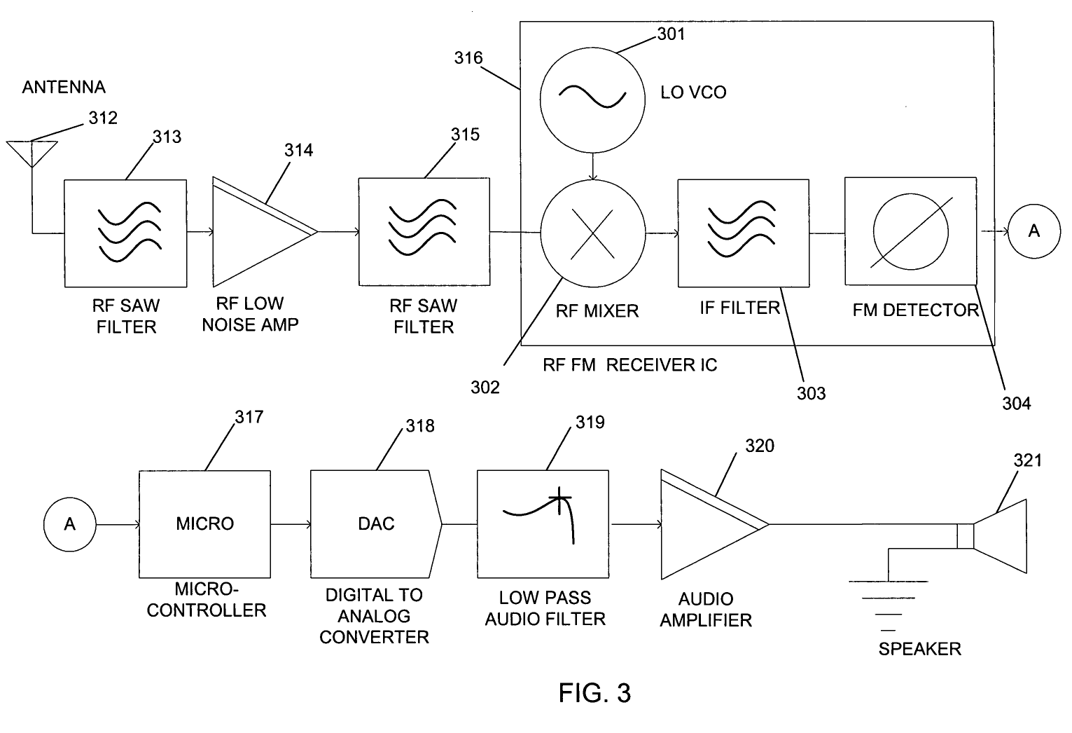

Referring to FIG. 3, a component diagram is provided of the components of a receiver 300 configured in accordance with the present invention. The receiver comprises an antenna 312 for receiving the audio information transmitted from the antenna 111 of the transmitter 100. Opposite the transmitter antenna 111, the antenna 312 converts radiated electromagnetic energy to radio frequency electrical energy. Similar to the transmitter antenna 111, the size of the receiver antenna 312 is determined by the frequency of the signal to be received; in the preferred embodiment, a one-half wavelength wire is sufficient.

The receiver 300 further comprises a filter 313, 315, 301. In one embodiment, the filter 313 is a radio frequency SAW filter 313, 315, discussed previously in the context of the transmitter 100. As in the transmitter 100, the SAW filter 313, 315 in the receiver 300 is for isolating a desired range of radio signal information from background noise, thereby increasing the clarify and range of the audio information. As illustrated in FIG. 3, a plurality of SAW filters 313, 315 may be included in the receiver 300 assembly; in particular, it is useful to provide a first SAW filter 313 prior to routing the audio information to a low noise amplifier 314, as will be herein discussed, and also a second SAW filter 315 to filter information output from the low noise amplifier 314.

The low noise amplifier 314 is provided in one embodiment, to enhance the strength of signals received from the transmitter 100, thereby increasing the operative distance at which transmitter 100 and receiver 300 may communicate. Amplifier 314 can be constructed of a discrete radio frequency transistor, or of MMIC amplifiers. In another embodiment, the receiver 300 further comprises an audio amplifier 320, for increasing the amplitude of the audio information before it is transmitted to the audio output 321. To adjust the sound level of the audio output 321, the audio amplifier 320 may be operably driven by a volume control operable by the user. Audio amplifier 320 is preferably, as will be understood by one of skill in the art, an integrated circuit device optimized for high audio voltage gain, with the ability to drive the low impedance of a standard speaker coil.

In a preferred embodiment, the receiver 300 further comprises a radio frequency receiver circuit 316, which detects, demodulates and amplifies received radio frequency signals. The radio frequency receiver circuit in turn comprises a voltage control oscillator 301, a radio frequency mixer 302, a filter 303 and a signal detector 304. As will be understood by one of skill the art, the radio frequency receiver circuit 316 is for selecting from among the electromagnetic information received by the antenna 312 the audio information transmitted at the selected frequency by the transmitter 100. Exemplary radio frequency receiver circuits for use in the present invention are available as model no. ML2722 from Micro Linear and model no. BH4127 from ROHM.

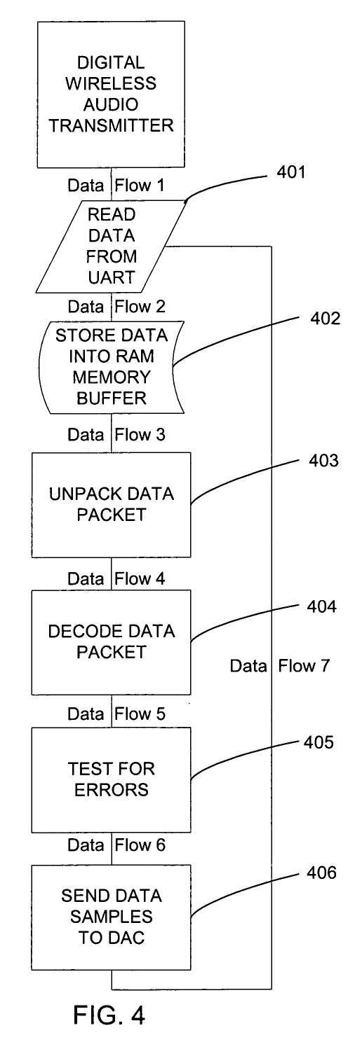

In one embodiment, the receiver further comprises a microcontroller 317, for routing information between the various electrical components of the receiver 300, and for performing various data operations upon the received audio information. Referring now to FIG. 4, there is illustrated a software flowchart for use in the microcontroller 317 of the receiver 300. At initial step 401, the audio information is received from the antenna 312 (or from another device such as the receiver circuit 316, which received the audio information from the antenna 312). As the audio information is received, it is in step 402 stored in a random access memory. In the preferred event that the audio information has been encoded into a data packet, the data packet is unpacked by the microcontroller 317, as will be understood by one of skill in the art, at step 403; i.e., the data packet is separated into its information and meta-data components as previously described with reference to the microcontroller 105 of the transmitter 100.

In the preferred event that the audio information transmitted from the transmitter 100 was encrypted, the microcontroller 317 next, at step 404, decrypts the encrypted audio information. Information necessary for decrypting the encrypted audio information may be pre-programmed into the microcontroller 317, or may be included in the meta-data of the transmitted audio information packet. In the preferred event that the meta-data associated with the audio information packet includes error checking information, the microcontroller 317 next, at step 405, uses that error checking information to verify that the audio information received from the transmitter 100 is received from error. The algorithms necessary for performing the decryption and error checking have been discussed in referenced to the transmitter 100, and will be understood by one of skill in the art. Lastly, at step 406, the microcontroller transmits the decrypted audio information to the next element in the electrical assembly of the receiver 300.

In one embodiment, the receiver 300 further comprises a digital-to-analog (“D/A”) converter 316, for translating received digital audio information into analog audio information so that it may be communicated to the audio output 321. Preferably and as previously discussed and as illustrated in FIG. 1, the audio information transmitted by the transmitter 100 is digital audio information. Before the received digital audio information may be communicated to the audio output 321, it must be translated into analog audio information. Therefore, in the preferred embodiment, the receiver 300 includes a D/A converter 318 for that purpose.

The receiver 300 further comprises an output 321. In a preferred embodiment, the audio output 321 is a standard speaker, an electro-acoustic transducer for converting electrical signals into sound audible by the user. In the preferred embodiment, the speaker 321 has an impedance between 8 and 32 ohms at up to 1 watt of voltage. Audio output 321 can also be an audio output port, such as a quarter-inch or eighth-inch stereo output port, or RCA output port.

As illustrated in FIG. 1 and FIG. 2 and described herein, it will be understood that the precise illustrated assemblies of the transmitter 100 and the receiver 300, i.e. the order and arrangement of the components, is not required to fulfill the objectives of the present invention. Other arrangements and orders of the various components are possible to achieve those objectives, without departing from the principles of the present invention.

While the specific embodiments have been illustrated and described, numerous modifications come to mind without significantly departing from the spirit of the invention, and the scope of protection is only limited by the scope of the accompanying Claims.

What is claimed is:

1. A wireless audio communication system, comprising:
a transmitter, comprising:
an input for receiving audio information;
a filter for modifying the audio information;
a converter for converting the audio information into a digital audio information; and
an antenna for transmitting the digital audio information at the selected radio frequency; and,
a receiver, comprising:
an antenna for receiving the digital audio information from the transmitter;
a filter for modifying the digital audio information;
a converter for converting the digital audio information into the audio information; and,
an output for communicating the audio information.

2. The system of claim 1, wherein the transmitter further comprises a microprocessor for constructing a data packet comprising the digital audio information.

3. The system of claim 2, wherein the receiver further comprises a microprocessor for processing the data packet.

4. The system of claim 1, wherein the transmitter further comprises a translator for translating the audio information into an encrypted audio information.

5. The system of claim 4, wherein the receiver further comprises a translator for translating the decrypted audio information into the audio information.

6. The system of claim 1, wherein the input is a microphone.

7. The system of claim 1, wherein the transmitter further comprises an amplifier to increase the clarity of the audio information.

8. The system of claim 1, wherein the transmitter further comprises a selector for selecting a radio frequency.

9. The system of claim 1, wherein the transmitter further comprises an amplifier to increase the transmission range of the antenna.

10. The system of claim 1, wherein the receiver further comprises an amplifier for improving the clarity of the audio information.

11. The system of claim 1, wherein the receiver further comprises a radio frequency filter for improving the clarity of the audio information.

12. A method for a wireless audio transmission, comprising the steps of:
receiving an audio information at a transmitter;
modifying the audio information with a filter;
converting the audio information into a digital audio information at the transmitter;
wirelessly transmitting the digital audio information;
receiving the digital audio information at a receiver;
converting the digital audio information into the audio information at the receiver; and,
communicating the audio information to an output.

13. The method of claim 12, further comprising the step of:
constructing a data packet at the transmitter, wherein the data packet comprises the digital audio information

14. The method of claim 13, further comprising step of:
processing the data packet at the receiver.

15. The method of claim 12, further comprising the step of:
translating the audio information into an encrypted audio information at the transmitter.

16. The method of claim 15, further comprising the step of:
translating the encrypted audio information into the audio information at the receiver.

17. The method of claim 12, further comprising the step of:
amplifying the audio information to improve the clarify of the audio information.

18. The method of claim 12, wherein the filter is a low-pass audio filter to improve the quality of the audio information.

19. The method of claim 12, further comprising the step of:
filtering radio frequency signals at the receiver to improve the quality of the audio information.

20. A system for the remote audio monitoring of an infant, comprising:
a transmitter positioned at the infant location, comprising:
a microphone for recording audio information;
a gain control for adjusting the recorded audio information;
an amplifier for amplifying the adjusted audio information;
a filter for modifying the audio information;
a converter for converting the audio information into a digital signal;
a translator for translating the digital signal into an encrypted digital signal;
a selector for selecting a radio frequency;
an antenna for transmitting the encrypted digital signal; and,
a second amplifier for increasing the transmission strength of the antenna; and,
a receiver, comprising:
an antenna for receiving the encrypted digital signal;
a translator for converting the encrypted digital signal into the digital signal;
a filter for modifying the digital signal;
a converter for converting the digital signal into a second audio information;
an amplifier for amplifying the second audio information;
a second filter for modifying the second audio information; and,
a speaker for communicating the second audio information.
